(19) United States
(12) Patent Application Publication
(10) Pub. No.: US 2008/0101246 A1
(43) Pub. Date: May 1, 2008

(54) Method and apparatus for packet reception and transmission in a wireless communications system

(75) Inventor: Sam Shiaw-Shiang Jiang, Taipei City (TW)

Correspondence Address: BIRCH STEWART KOLASCH & BIRCH, PO BOX 747, FALLS CHURCH, VA, 22040-0747, US

(73) Assignee: Innovative Sonic Limited, Tortola (VG)

(21) Appl. No.: 11/979,062

(22) Filed: Oct. 30, 2007

Related U.S. Application Data
(60) Provisional application No. 60/855,407, filed on Oct. 31, 2006.

(51) Int. Cl. G06F 11/00

(52) U.S. Cl. 370/241

(57) ABSTRACT

A packet transmission method for a transmitter in a wireless communications system, for enhancing transmission efficiency when sporadic data transmission is needed, is disclosed. The packet transmission method includes initiating an HARQ procedure, triggering a transmission of a packet, and sending the packet repetitively until a predefined number of ACKs corresponding to the packet are received.

### CROSS REFERENCE TO RELATED APPLICATIONS

This application claims the benefit of U.S. Provisional Application No. 60/855,407, filed on Oct. 31, 2006 and entitled “Method and apparatus of Adaptive Fast Hybrid ARQ”, the contents of which are incorporated herein by reference.

### BACKGROUND OF THE INVENTION

1. Field of the Invention

The present invention relates to a method and apparatus for packet reception and transmission in a wireless communications system, and more particularly to a method and related apparatus for fully utilizing the radio resources, so as to enhance transmission efficiency.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting third generation mobile telecommunication technology, the prior art provides High Speed Downlink Package Access (HSDPA) and High Speed Uplink Package Access (HSUPA), which are used to increase bandwidth utility rate and package data processing efficiency to improve uplink/downlink transmission rate.

In the prior art, HSDPA and HSUPA adopt Hybrid Automatic Repeat Request (HARQ) technology to enhance retransmission rate and reduce transmission delay. HARQ is a technology combining Feed-forward Error Correction (FEC) and ARQ methods, and uses a “Multi-channel Stop and Wait” algorithm, meaning that each channel decides to retransmit a packet or transmit the next packet according to positive/negative acknowledgement signals (ACK/NACK) reported by the receiver.

For example, please refer to FIG. 1, which illustrates a schematic diagram of the operation of the prior art HARQ procedure. In FIG. 1, a transmitter Tx sends packets PKT_1, PKT_2 . . . to a receiver Rx through channels CH1, CH2, CH3, and CH4. After the packet PKT_1 is sent, the channel CH1 stops transmitting and waits for corresponding ACK/NACK. Meanwhile, other channels will sequentially send the packets PKT_2, PKT_3, and PKT_4, and wait for corresponding acknowledgement signals. In FIG. 1, the channel CH1 receives a NACK corresponding to the packet PKT_1 after a round trip time RTT, and the channel CH1 retransmits the packet PKT_1. Next, when the channel CH2 receives an ACK corresponding to the packet PKT_2, the channel CH2 transmits the next packet PKT_5. As a result, each channel can decide to retransmit a packet or transmit the next packet according to ACK/NACK reported by the receiver.

Therefore, the “Multi-channel Stop and Wait” algorithm can fully utilize the radio resources, to enhance transmission efficiency. However, for applications, such as shooting or gambling games, that transmit sporadic data but need extremely short transmission delay, the “Multi-channel Stop and Wait” scheme does not fully utilize the radio resources, and may affect fluency of the games. For example, in FIG. 2, there is no other packet except the packet PKT_1 to be sent to the receiver, where notations and corresponding meanings are the same as those in FIG. 1. As mentioned above, the “Multi-channel Stop and Wait” algorithm means that each channel decides to retransmit a packet or transmit the next packet according to corresponding acknowledgement signals reported by the receiver, so that the transmitter can retransmit a packet after a corresponding NACK is received. That is, each retransmission of the packet can only be triggered after an RTT. Take FIG. 2 for example, transmission of the packet PKT_1 fails twice, so that the transmission delay time is at least twice of RTT.

In order to improve the above-mentioned problem, a scheme of multiple transmissions has been introduced to improve transmission delay for AM (Acknowledgment Mode), which transmits a packet or a message for a predefined number of times without waiting for NACKs. The multiple_transmission scheme can also apply on HARQ. However, the drawback of the multiple_transmission scheme is that the predefined number of times does not ensure successful transmission of the packets if the predefined number of times is not properly configured.

In short, for applications that transmit sporadic data but need extremely short transmission delay, the prior art HARQ procedure does not fully utilize the radio resources.

### SUMMARY OF THE INVENTION

According to the present invention, a packet transmission method for a transmitter in a wireless communications system, for enhancing transmission efficiency when sporadic data transmission is needed, is disclosed. The packet transmission method comprises initiating an HARQ procedure, triggering a transmission of a packet, and sending the packet repetitively until a predefined number of ACKs corresponding to the packet are received.

According to the present invention, a communications device of a wireless communications system utilized for enhancing transmission efficiency when sporadic data transmission is needed is disclosed. The communications device comprises a control circuit for realizing functions of the communications device, a processor installed in the control circuit for executing a program code to operate the control circuit, and a memory coupled to the processor for storing the program code. The program code comprises code for initiating an HARQ procedure, code for triggering a transmission of a packet, and code for sending the packet repetitively until a predefined number of ACKs corresponding to the packet are received.

According to the present invention, a packet reception method for a receiver in a wireless communications system, for enhancing transmission efficiency when sporadic data transmission is needed, is disclosed. The packet reception method comprises initiating an HARQ procedure, receiving a packet, decoding the packet, and not sending a NACK corresponding to the packet when the packet is not successfully decoded.

According to the present invention, a communications device of a wireless communications system utilized for enhancing transmission efficiency when sporadic data transmission is needed is disclosed. The communications device comprises a control circuit for realizing functions of the communications device, a processor installed in the control circuit for executing a program code to operate the control circuit, and a memory coupled to the processor for storing the program code. The program code comprises code for initiating an HARQ procedure, code for receiving a packet, code for decoding the packet, and code for not sending a NACK corresponding to the packet when the packet is not successfully decoded.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams of operations of the prior art HARQ procedure.

FIG. 3 is a function block diagram of a wireless communications device.

FIG. 4 is a diagram of program code of FIG. 3.

FIG. 5 is a flowchart of a process according to an embodiment of the present invention.

FIG. 6 is a schematic diagram of transmission of a packet according to the process shown in FIG. 5.

FIG. 7 is a flowchart of a process according to another embodiment of the present invention.

### DETAILED DESCRIPTION

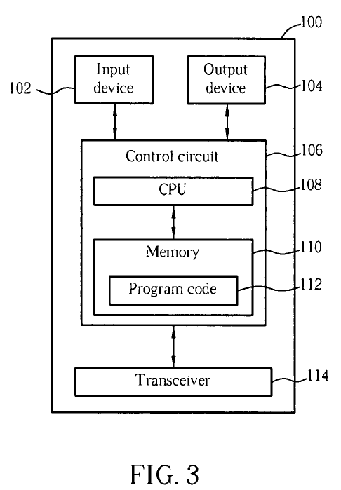

Please refer to FIG. 3, which is a functional block diagram of a communications device 100. For the sake of brevity, FIG. 3 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

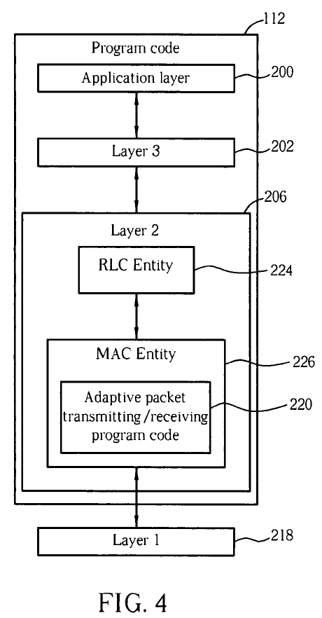

Please continue to refer to FIG. 4. FIG. 4 is a diagram of the program code 112 shown in FIG. 3. The program code 112 includes an application layer 200, a Layer 3 202, and a Layer 2 206, and is coupled to a Layer 1 218. The Layer 2 206 comprises two sub-layers: a radio link control (RLC) entity 224 and a media access control (MAC) entity 226. A primary function of the RLC entity 224 is providing different transmission quality processing, performing segmentation, reassembly, concatenation, padding, retransmission, sequence check, and duplication detection on transmitted data or control instructions based on different transmission quality requirements. The MAC entity 226 can match packets received from different logic channels of the RLC entity 224 to common, shared, or dedicated transport channels according to radio resource allocation commands of the Layer 3 (RRC layer) 202, for performing channel mapping, multiplexing, transport format selection, or random access control.

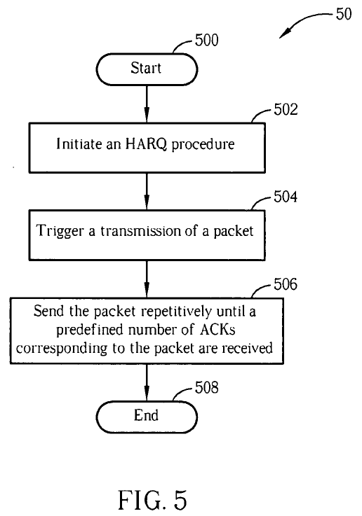

In some applications, such as when realizing HSDPA or HSUPA, the MAC entity 226 can execute an HARQ procedure, and retransmit packets based on acknowledgement signals outputted from a receiver. In such a situation, the embodiment of the present invention provides an adaptive packet transmitting/receiving program code 220 utilized for enhancing transmission efficiency when sporadic data transmission is needed, so as to reduce transmission delay in the HARQ procedure. Please refer to FIG. 5, which is a flowchart diagram of a process 50 according to the present invention. The process 50 is utilized in a transmitter of the wireless communication system for enhancing transmission efficiency when sporadic data transmission is needed, and can be compiled into the adaptive packet transmitting/receiving program code 220. The process 50 comprises the following steps:
Step 500: Start.
Step 502: Initiate an HARQ procedure.
Step 504: Trigger a transmission of a packet.
Step 506: Send the packet repetitively until a predefined number of ACKs corresponding to the packet are received.
Step 508: End.

According to the process 50, the embodiment of the present invention repetitively sends a packet until a predefined number of ACKs corresponding to the packet are received in the HARQ procedure. Preferably, the embodiment of the present invention repetitively sends the packet in every transmission time interval (TTI) until the predefined number of positive acknowledgment signals corresponding to the packet are received, and the predefined number can be any integer greater than or equal to 1.

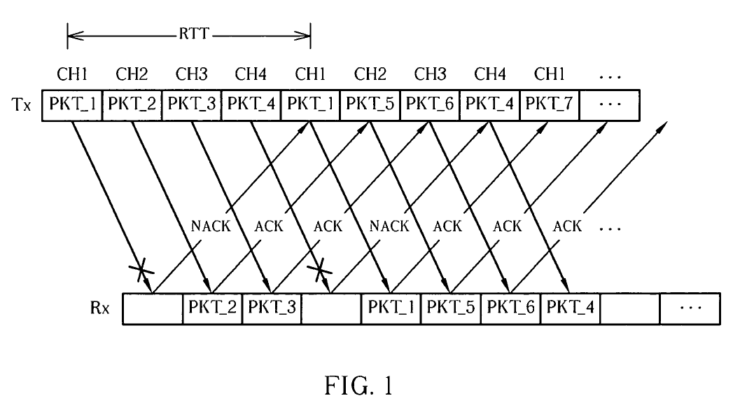

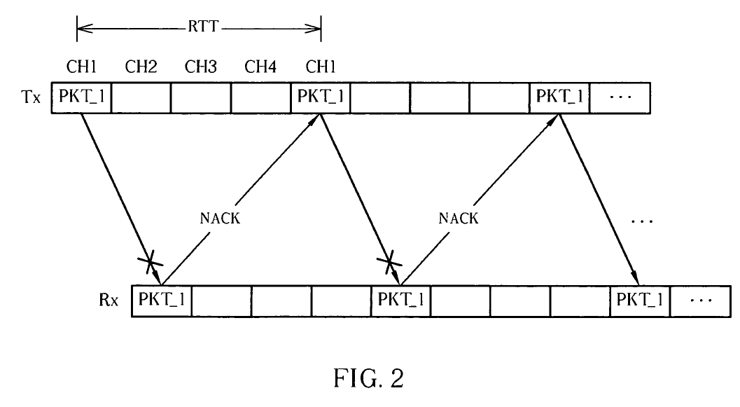

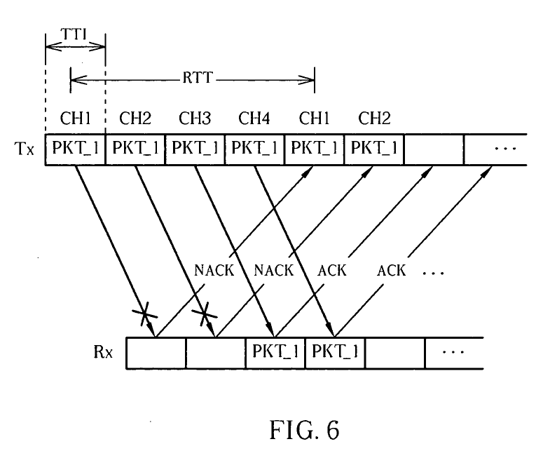

Therefore, via the process 50, the transmitter stops sending a packet when at least one ACK corresponding to the packet is received. As a result, for applications that transmit sporadic data but need extremely short transmission delay, the embodiment of the present invention can fully utilize the radio resources and enhance transmission efficiency. For example, please refer to FIG. 6, which illustrates a schematic diagram of transmission of a packet PKT_1 according to the process 50. For clarity, notations and corresponding meanings are the same as those in FIG. 1. As shown in FIG. 6, before an ACK corresponding to the packet PKT_1 is received, the embodiment of the present invention repetitively sends the packet PKT_1 in every TTI. Therefore, even if transmission of the packet PKT_1 fails twice (the transmitter Tx receives two ACKs), since the transmitter Tx repetitively sends the packet PKT_1 before receiving the corresponding ACK, the transmission delay time is twice of TTI (comparing to non-failure transmission) in the embodiment of the present invention. In comparison, in the prior art, the transmission delay time is at least twice of RTT. Therefore, the embodiment of the present invention can reduce transmission delay, especially for applications that transmit sporadic data but need extremely short transmission delay.

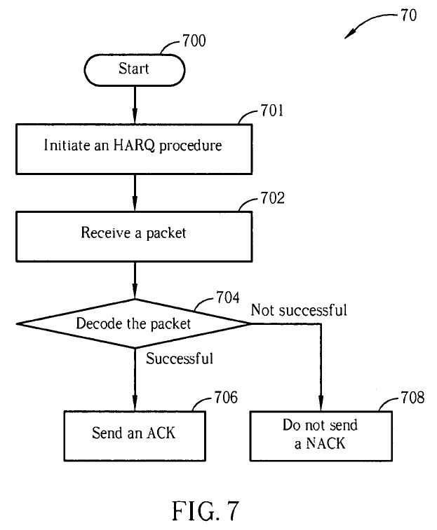

To cooperate with the process 50, please refer to FIG. 7, which is a flowchart diagram of a process 70 according to the present invention. The process 70 is utilized in a receiver of the wireless communication system for enhancing transmission efficiency when sporadic data transmission is needed, and can be compiled into the adaptive packet transmitting/receiving program code 220. The process 70 comprises the following steps:
Step 700: Start.
Step 701: Initiate an HARQ procedure.
Step 702: Receive a packet.
Step 704: Decode the packet. If the packet is successfully decoded, go to step 706; else, go to step 708.
Step 706: Send an ACK.
Step 708: Do not send a NACK.

According to the process 70, the embodiment of the present invention sends an ACK corresponding to a received packet only when the packet is successfully decoded. For example, when the packet is not successfully decoded, the embodiment of the present invention does not output a NACK corresponding to the packet. Preferably, the number of times the ACK corresponding to the packet has been sent is smaller than or equal to a predefined number, which can be any value greater than 1, such as 2, 3, or (RTT/TTI)−1. Consequently, after the number of the times the ACK corresponding to the packet has been sent is greater than the predefined number, the receiver does not respond any ACK for the same received packet, so as to save radio resources.

Through the processes 50 and 70, the transmitter repetitively sends a packet until a corresponding ACK reported by the receiver is received, while the receiver reports an ACK corresponding to a received packet only when the packet is successfully decoded and the number of times the ACK has been sent is smaller than or equal to the predefined number. In such a situation, even in a poor radio condition, especially in applications that transmit sporadic data but need extremely short transmission delay, the embodiment of the present invention can ensure efficient transmission, and reduce radio resource waste.

In summary, the embodiment of the present invention can fully utilize the radio resources, so as to enhance transmission efficiency, especially for applications that transmit sporadic data but need extremely short transmission delay.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet transmission method for a transmitter in a wireless communications system, for enhancing transmission efficiency when sporadic data transmission is needed, the packet transmission method comprising:
initiating a hybrid automatic repeat request procedure;
triggering a transmission of a packet; and
sending the packet repetitively until a predefined number of positive acknowledgment signals corresponding to the packet are received.

2. The packet transmission method of claim 1, wherein sending the packet repetitively until the predefined number of positive acknowledgment signals corresponding to the packet are received is repetitively sending the packet in every transmission time interval until the predefined number of positive acknowledgment signals corresponding to the packet are received.

3. The packet transmission method of claim 1, wherein the predefined number is 1.

4. The packet transmission method of claim 1, wherein the predefined number is greater than 1.

5. A communications device of a wireless communications system utilized for enhancing transmission efficiency when sporadic data transmission is needed, the communications device comprising:
a control circuit for realizing functions of the communications device;
a processor installed in the control circuit for executing a program code to operate the control circuit; and
a memory coupled to the processor for storing the program code;
wherein the program code comprises:
initiating a hybrid automatic repeat request procedure;
triggering a transmission of a packet; and
sending the packet repetitively until a predefined number of positive acknowledgment signals corresponding to the packet are received.

6. The communications device of claim 5, wherein sending the packet repetitively until the predefined number of positive acknowledgment signals corresponding to the packet are received is repetitively sending the packet in every transmission time interval until the predefined number of positive acknowledgment signals corresponding to the packet are received.

7. The communications device of claim 5, wherein the predefined number is 1.

8. The communications device of claim 5, wherein the predefined number is greater than 1.

9. A packet reception method for a receiver in a wireless communications system, for enhancing transmission efficiency when sporadic data transmission is needed, the packet reception method comprising:
initiating a hybrid automatic repeat request procedure;
receiving a packet;
decoding the packet; and
not sending a negative acknowledgment signal corresponding to the packet when the packet is not successfully decoded.

10. The packet reception method of claim 9 further comprising sending a positive acknowledgment signal corresponding to the packet when the packet is successfully decoded.

11. The packet reception method of claim 10, wherein sending the positive acknowledgment signal corresponding to the packet when the packet is successfully decoded is sending the positive acknowledgment signal corresponding to the packet when the packet is successfully decoded and the number of times the positive acknowledgment signal has been sent is smaller than or equal to a predefined number.

12. The packet reception method of claim 11, wherein the predefined number is 2.

13. The packet reception method of claim 11, wherein the predefined number is 3.

14. The packet reception method of claim 11, wherein the predefined number is a result of subtracting 1 from a ratio of a round trip time to a transmission time interval.

15. A communications device of a wireless communications system utilized for enhancing transmission efficiency when sporadic data transmission is needed, the communications device comprising:
a control circuit for realizing functions of the communications device;
a processor installed in the control circuit for executing a program code to operate the control circuit; and
a memory coupled to the processor for storing the program code;
wherein the program code comprises:
initiating a hybrid automatic repeat request procedure;
receiving a packet;
decoding the packet; and
not sending a negative acknowledgment signal corresponding to the packet when the packet is not successfully decoded.

16. The communications device of claim 15, wherein the program code further comprises sending a positive acknowledgment signal corresponding to the packet when the packet is successfully decoded.

17. The communications device of claim 16, wherein sending the positive acknowledgment signal corresponding to the packet when the packet is successfully decoded is sending the positive acknowledgment signal corresponding to the packet when the packet is successfully decoded and the number of times the positive acknowledgment signal has been sent is smaller than or equal to a predefined number.

18. The communications device of claim 17, wherein the predefined number is 2.

19. The communications device of claim 17, wherein the predefined number is 3.

20. The communications device of claim 17, wherein the predefined number is a result of subtracting 1 from a ratio of a round trip time to a transmission time interval.
